(19) United States
(12) Patent Application Publication
(10) Pub. No.: US 2006/0225903 A1
(43) Pub. Date: Oct. 12, 2006

(54) Rotary impact tool, shock attenuating coupling device for a rotary impact tool, and rotary impact attenuating device

(76) Inventors: Robert E. Sterling, Spokane, WA (US); Matthew R. Sterling, Spokane, WA (US)

Correspondence Address: WELLS ST. JOHN P.S., 601 W. FIRST AVENUE, SUITE 1300, SPOKANE, WA, 99201, US

(21) Appl. No.: 11/101,842

(22) Filed: Apr. 7, 2005

(51) Int. Cl. B25D 11/00

(52) U.S. Cl. 173/104

(57) ABSTRACT

A shock attenuating coupling device is provided for a rotary impact tool for drivingly connecting a hammer mechanism to a drive anvil. The shock attenuating coupling device includes a first coupling member, a second coupling member, and a body of resilient material. The first coupling member has a longitudinal drive portion with an input end configured to couple for rotation with a hammer mechanism and an output end with a first jaw portion. The second coupling member has an output end configured to couple for rotation with a drive anvil and an input end with a second jaw portion configured to cooperate in longitudinally overlapping and circumferentially spaced-apart relation with the first jaw portion. The body of resilient material is interposed between the first jaw portion and the second jaw portion. A rotary impact tool with the shock attenuating coupling device is also provided.

### TECHNICAL FIELD

This invention pertains to rotary impact tools. More particularly, the present invention relates to rotary impact tools having a transient torque absorbing drive coupling provided intermediate a hammer mechanism and a drive anvil.

### BACKGROUND OF THE INVENTION

Numerous designs are known for making rotary impact tools. U.S. Pat. Nos. 2,285,638; 3,661,217; and 6,491,111 disclose several variations of rotary impact tools having conventional rotary impact mechanisms. Such mechanisms are configured to deliver rotary forces via a series of transient impact blows which enables a human operator to handle the impact wrench while delivering relatively high torque forces in short duration impact blows. By applying relatively short duration high torque impact blows, a normal human being is rendered with the ability to physically hold onto the impact wrench while rendering the relatively high torque forces. If these forces were delivered in a continuous manner, a human operator would be required to impart an opposite continuous reaction force on the impact wrench which would prove to be too great for the operator.

One problem with the rotary impact tools mentioned above is the inability to deliver relatively high torque forces in short duration impact blows while reducing the peak transient forces generated at the instance of impact within the rotary impact mechanism.

Accordingly, it would be advantageous to control, or limit transmission of peak transient forces that are generated via a rotary impact mechanism of a rotary impact tool to an anvil.

### SUMMARY OF THE INVENTION

A shock attenuating coupling device is provided for use on a rotary impact tool between an impact mechanism and an anvil. One or more resilient members are configured to interact between a drive shaft and a driven shaft in order to provide a resilient rotary coupling device interposed between a hammer mechanism and a drive anvil. In one case, a torsion spring is mounted between a first coupling member of the drive shaft and a second coupling member of the driven shaft. In another case, one or more springs are provided between inter-digitating respective fingers on a drive shaft and a driven shaft. In each case, the impact mechanism can take on any known form including a single (or double) swing weight hammer mechanism, as well as a twin pin (or twin cock) hammer mechanism. In all such cases, the resilient rotary coupling device is configured to attenuate impacts from the hammer mechanism to the drive anvil. In one case, the impact mechanism is a rotary impact mechanism.

According to one aspect, a shock attenuating coupling device is provided for a rotary impact tool for drivingly connecting a hammer mechanism to a drive anvil. The shock attenuating coupling device includes a first coupling member, a second coupling member, and a body of resilient material. The first coupling member has a longitudinal drive portion with an input end configured to couple for rotation with a hammer mechanism and an output end with a first jaw portion. The second coupling member has an output end configured to couple for rotation with a drive anvil and an input end with a second jaw portion configured to cooperate in longitudinally overlapping and circumferentially spaced-apart relation with the first jaw portion. The body of resilient material is interposed between the first jaw portion and the second jaw portion.

According to another aspect, a rotary impact tool is provided having a housing, a hammer mechanism, a drive anvil, and a resilient rotary coupling device. The resilient rotary coupling device is interposed between the hammer mechanism and the drive anvil. The resilient rotary coupling device is configured to attenuate impact from the hammer mechanism to the drive anvil.

According to yet another aspect, a rotary impact attenuating device is provided for an impact tool. The rotary impact attenuating device includes a first coupling member, a second coupling member, and a spring. The first coupling member has a drive shaft and at least one engagement surface. The second coupling member has a driven shaft and at least one engagement surface configured to overlap and interdigitate with a respective one of the at least one engagement surface on the first coupling device. The spring is mounted between the first coupling member of the drive shaft and the second coupling member of the driven shaft to impart rotary resilience between the first coupling member and the second coupling member.

### BRIEF DESCRIPTION OF THE DRAWINGS

Preferred embodiments of the invention are described below with reference to the following accompanying drawings.

FIG. 1 is a side elevational view of a rotary impact tool having a shock attenuating coupling device interposed between a rotary impact mechanism and an anvil in accordance with one embodiment of the present invention.

FIG. 2 is an enlarged partial view, shown in vertical centerline cross-section, of an air supply, trigger mechanism, and muffler provided in a handle of the rotary impact tool of FIG. 1.

FIG. 3 is a simplified, exploded perspective view of the rotary impact tool of FIGS. 1-2.

FIG. 4 is an enlarged partial view, shown in partial vertical centerline cross-section, of a pneumatic valve, pneumatic motor, rotary impact mechanism, shock attenuating coupling device, and anvil for the rotary impact tool of FIGS. 1-3.

FIG. 5 is an enlarged, exploded and perspective view of the shock attenuating coupling device of FIG. 4.

FIG. 6 is an enlarged, partially exploded and perspective view of the shock attenuating coupling device, anvil, and hammer for the rotary impact tool of FIGS. 1-4.

FIG. 7 is an enlarged, perspective view of the shock attenuating coupling device, anvil, and hammer of FIG. 6 in an assembled state and illustrating the single swing weight hammer assembly with the swing weight in a first position.

FIG. 8 is a an enlarged, perspective view of the shock attenuating coupling device, anvil, and hammer of FIG. 7 in an assembled state and illustrating the single swing weight hammer assembly with the swing weight in a second position.

FIG. 9 is a cross-sectional view of the shock attenuating coupling device taken along line 9-9 of FIG. 5 illustrating the device prior to being torsionally loaded with an impact from an impact hammer.

FIG. 10 is a cross-sectional view of the shock attenuating coupling device of FIG. 9 taken along line 10-10 of FIG. 5 and illustrating the device when torsionally loaded into a compliant displacement position with an impact from an impact hammer.

FIG. 11 is an enlarged partial view, shown in partial vertical centerline cross-section, of an alternative construction rotary impact tool having a shock attenuating coupling device similar to that depicted in FIGS. 1-10 according to another aspect of the present invention.

FIG. 12 is an enlarged, exploded and perspective view of the shock attenuating coupling device, anvil, and hammer for the rotary impact tool of FIG. 11.

FIG. 13 is an enlarged partial view, shown in partial vertical centerline cross-section, of a second alternative construction rotary impact tool having an alternative construction shock attenuating coupling device over that depicted in FIGS. 1-10 and FIGS. 11-12 according to yet another aspect of the present invention.

FIG. 14 is an enlarged, exploded and perspective view of the shock attenuating coupling device and anvil for the rotary impact tool of FIG. 13.

FIG. 15 is an enlarged, exploded and perspective view of an alternative configuration for the shock attenuating coupling device of FIG. 14 for use in the rotary impact tool of FIG. 13.

FIG. 16 is an enlarged, exploded and perspective view of a second alternative configuration for the shock attenuating coupling device of FIG. 14 for use in the rotary impact tool of FIG. 13.

FIG. 17 is an enlarged, partially exploded and perspective view of the shock attenuating coupling device, anvil, and hammer of FIG. 14 for use in the rotary impact tool of FIG. 13.

FIG. 18 is an enlarged, perspective view of the shock attenuating coupling device, anvil, and hammer of FIG. 17 in an assembled state and illustrating the single swing weight hammer assembly with the swing weight in a first position.

FIG. 19 is a an enlarged, perspective view of the shock attenuating coupling device, anvil, and hammer of FIG. 17 in an assembled state and illustrating the single swing weight hammer assembly with the swing weight in a second position.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to several embodiments of Applicants' invention for a rotary impact tool having a shock attenuating coupling device between an impact mechanism and an anvil. While the invention is described by way of several embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

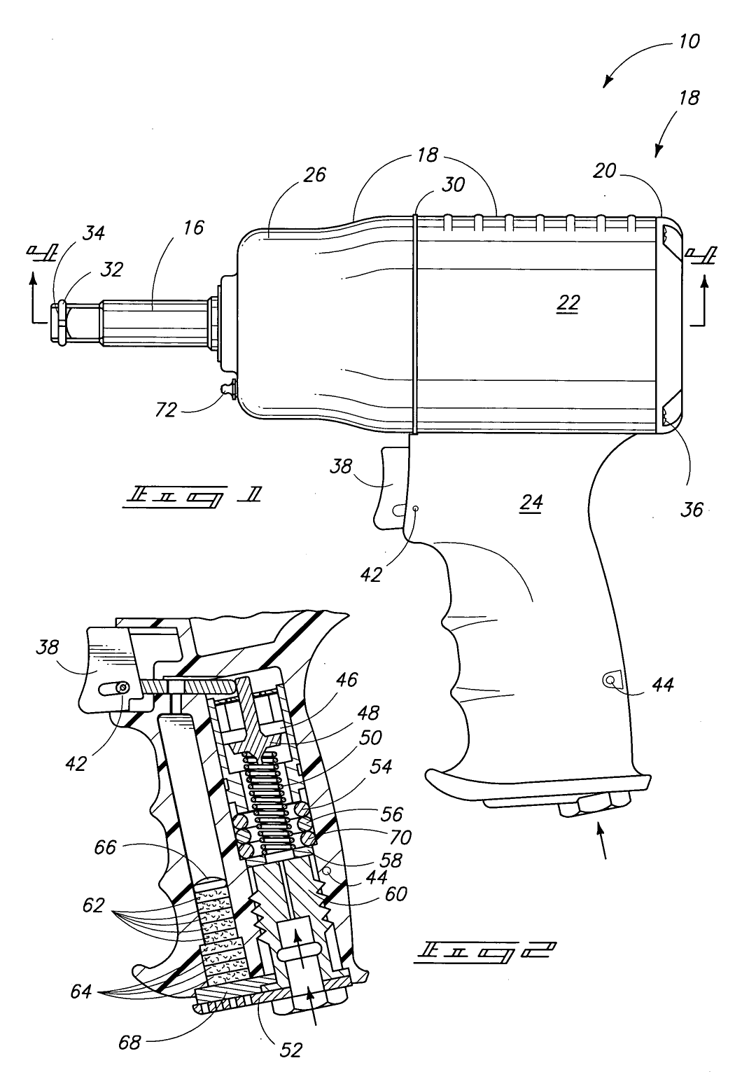

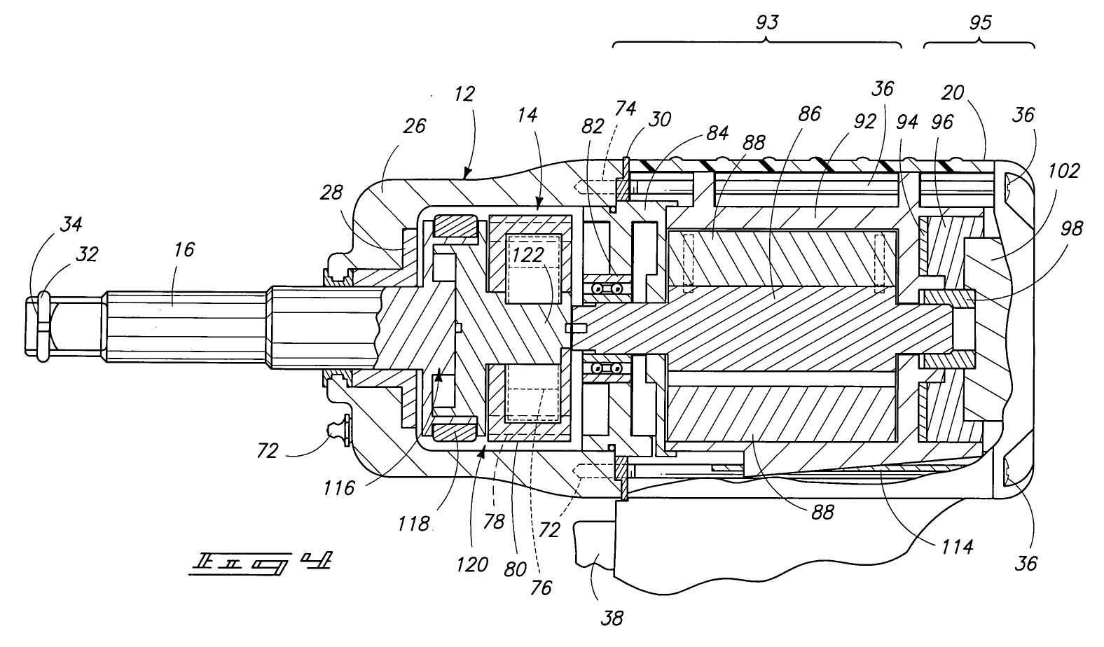

FIGS. 1-11 illustrate a rotary impact tool in the form of a pneumatic impact wrench 10 according to one aspect of the present invention. More particularly, impact wrench 10 is provided with a resilient rotary coupling device 12 (see FIGS. 3-10) that is provided between an impact mechanism, or hammer 14, and an anvil 16. According to one construction, the resilient coupling device provides resilient, or shock-attenuating rotational coupling in a forward direction, but provides no resilience in an opposite, reverse direction. Hence, when used in a torque wrench, the resilient coupling device limits peak transient impact loads being generated from the wrench and transferred to the anvil when tightening a fastener with a drive socket (not shown) that is provided on the anvil. However, the torque wrench generates greater peak transient impact loads when operated in a reverse, or loosening direction, which ensures that greater forces are generated for loosening a secured fastener. However, an optional configuration provides springs that act in forward and reverse directions to provide resilient rotational coupling in both forward and reverse directions.

As shown in FIG. 1, wrench 10 has a tool housing 18 comprising a motor housing member 20 and a hammer housing member, or nose piece, 26. Motor housing member 20 includes a hollow motor casing 22 and an integrally formed handle 24. Optionally, handle 24 can be formed from a separate piece that is fastened onto casing 22. A resilient front gasket 30 is provided between members 20 and 26 via four screws 36. Anvil 16 terminates at a distal end with an anvil collar 32 provided about a resilient o-ring 34 within a recess about anvil 16. Anvil collar 32 is urged in compression in a radially-inward direction when retaining and releasing an impact socket, or tool from anvil 16.

Handle 24 of impact wrench 10 includes a trigger 38 that is guided for compression and release via a force-fit spring pin 42, as shown in FIG. 1. Additionally, a grease fitting 72 is provided on housing member 26 to enable application of grease to internal components of impact wrench 10. Another spring pin 44 is provided in handle 24 to anchor air inlet fitting, or member, 60.

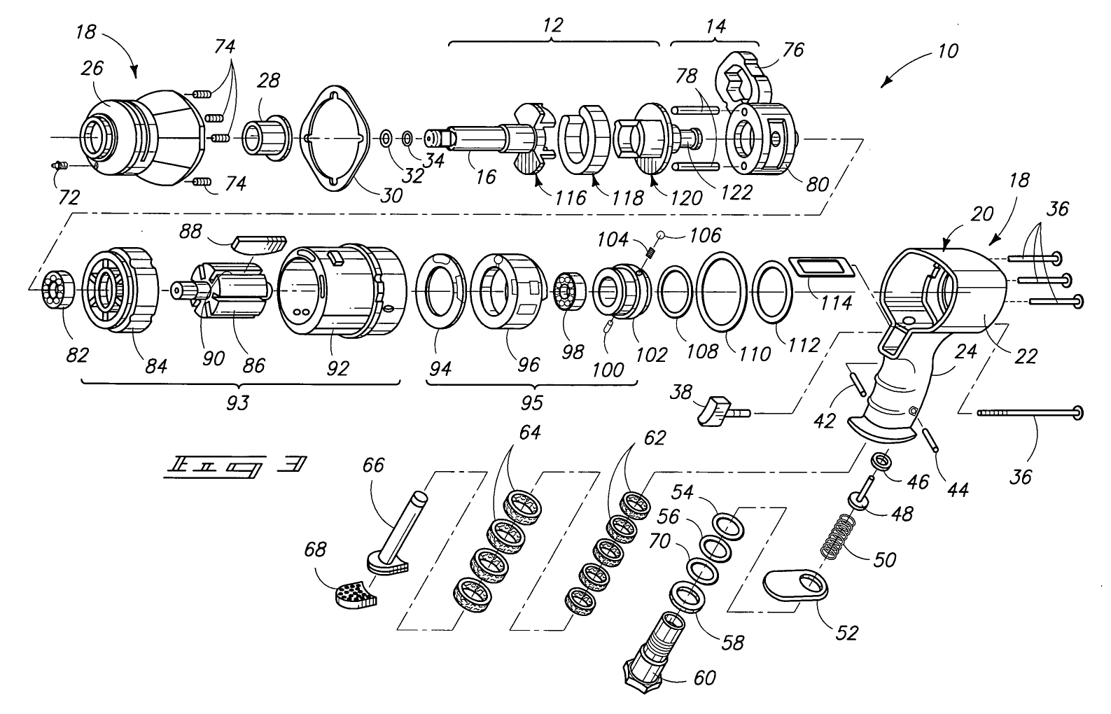

FIG. 2 illustrates assembly of an air supply, trigger mechanism, and muffler within handle 24 of impact wrench 10 of FIG. 1. More particularly, a trigger mechanism is provided by trigger 38 which acts via pin 42 to move and tilt a valve stem 48 relative to a bushing 46 while acting against a coil seat spring 50. When depressed, trigger 38 moves valve stem 48 to an open, unsealed position relative to bushing 46 to deliver air from a source into the impact wrench. The trigger mechanism includes o-rings 54, 56, and 70 seated against a washer 58 atop an air inlet member 60 configured to receive air from an air supply such as a pressurized air line (not shown). A muffler is provided within handle 24 by two stacks of wool felt rings 62, 64 each configured with a ring-shape for mounting about an exhaust tube 66. Exhaust air from the impact wrench is received through felt rings 62, 62, tube 66 and through a muffler 68 where it exists handle 24 via a plurality of apertures in an exhaust deflector 52. FIG. 3 further illustrates these features, along with additional construction details, as discussed below.

FIG. 3 further illustrates component assembly of pneumatic impact wrench 10 of FIGS. 1-2. More particularly, housing member 20 is joined to housing member 26 using screws 36 (several shown in partial breakaway view) which thread into complementarily threaded insert pieces 74 that are threaded into member 20. Anvil 16 of resilient rotary coupling device 12 is received for rotation through an anvil bushing 28 within member 26. Device 12 is directly joined to impact mechanism 14. Impact mechanism 14 comprises a single hammer construction having a hammer 76, a pair of hammer pins 78, and a hammer cage 80. Hammer cage 80 is mounted for rotation onto a pneumatic motor 93 which drives cage 80 in rotation to generate impacts between hammer 76 and a hammer shank 122. An air valve 95 enables adjustment of air supply to motor 93 to vary operating parameters for impact wrench 10.

Motor 93 includes a front end plate 84, a rotor 86, a plurality of rotor blades 88, and a cylinder 92. Each blade 88 is received in a respective slot 90 provided in circumferentially spaced-apart positions along rotor 86. End plate 84 receives a ball bearing assembly 82 that supports a front end of rotor 90. Cylinder 92 also receives a valve sleeve gasket 94 and a valve sleeve 96. Valve sleeve 96 receives a ball bearing assembly 98 that supports a back end of rotor 86. A reverse valve 102, an o-ring 108, a rear gasket 110, and a washer 112 are assembled between valve sleeve 96 and motor casing 22. Reverse valve 102 supports a spring pin 100, a spring 104 and a steel ball 104. An air channel gasket 114 is also mounted within motor casing 22.

According to one embodiment of the present invention, resilient rotary coupling device 12 comprises a jaw portion 116, a c-shaped spring 118, and another jaw portion 120. Jaw portion 120 is directly coupled to a hammer shank 122 which is driven via intermittent impacts with hammer 76 due to rotation of cage 80 via motor 93. In operation, anvil 16 receives an impact socket that is coupled to a fastener. With each impact, jaw portion 120 is driven in rotation. As anvil 16 meets greater resistance due to a tightening fastener, jaw portion 116 resists rotation while jaw portion 120 continues to be loaded from torsional, transient impacts. Spring 118 flexes torsionally under such conditions so as to attenuate peak impact force transmission between the hammer impact mechanism 14 and the anvil 16. Spring 118 provides the characteristics of a shock attenuating coupling device within the rotary impact tool, or impact wrench, 10.

Jaw portion 116 is provided as part of a second coupling member and jaw portion 120 is provided as part of a first coupling member. The first coupling member has a longitudinal drive portion with an input end configured to couple for rotation with a hammer mechanism 14 and an output end with a first jaw portion 120. The second coupling member has an output end configured to couple for rotation with a drive anvil 16 and an input end with a second jaw portion 116 configured to cooperate in longitudinally overlapping and circumferentially spaced-apart relation. Spring 118 provides a body of resilient material that is interposed between the first jaw portion and the second jaw portion.

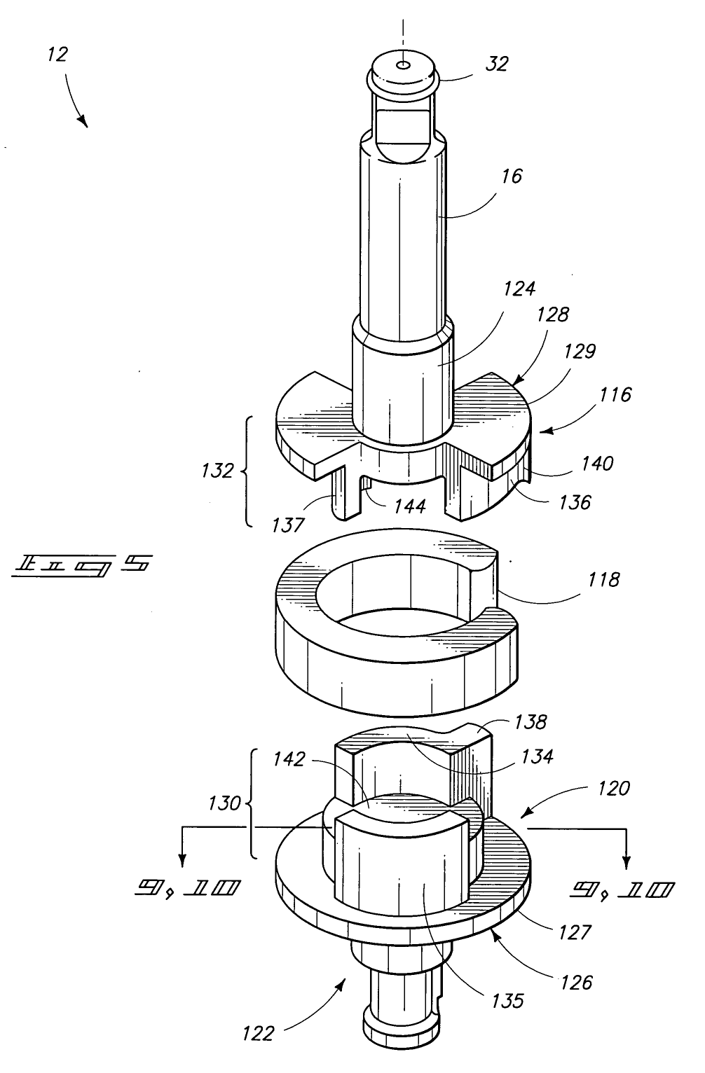

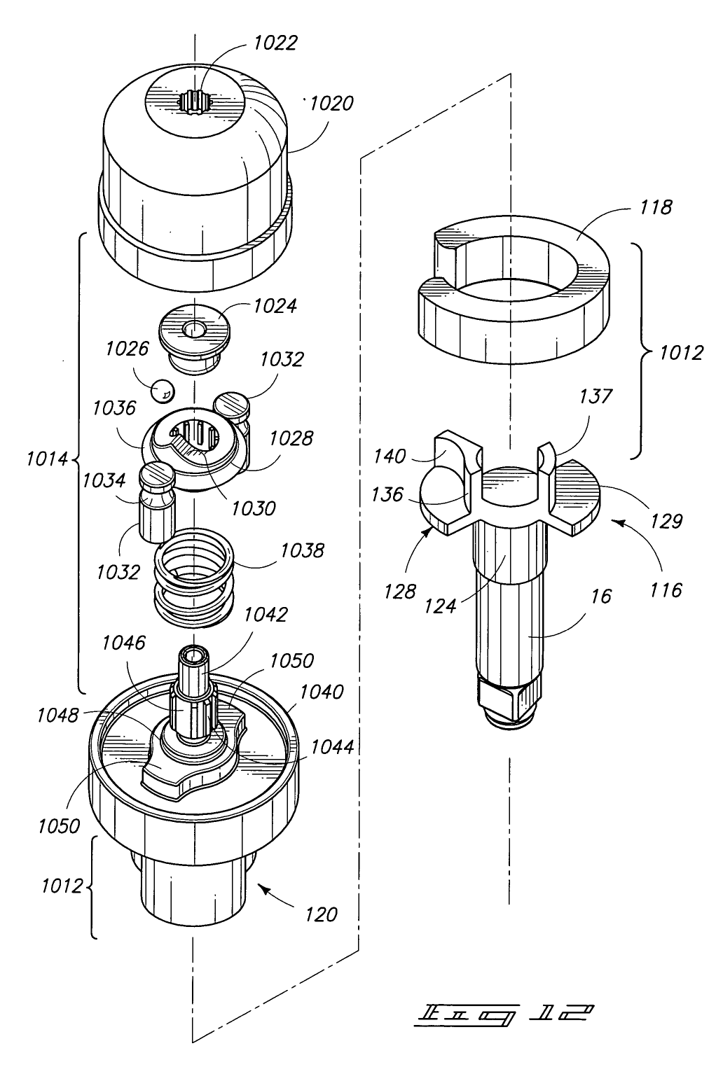

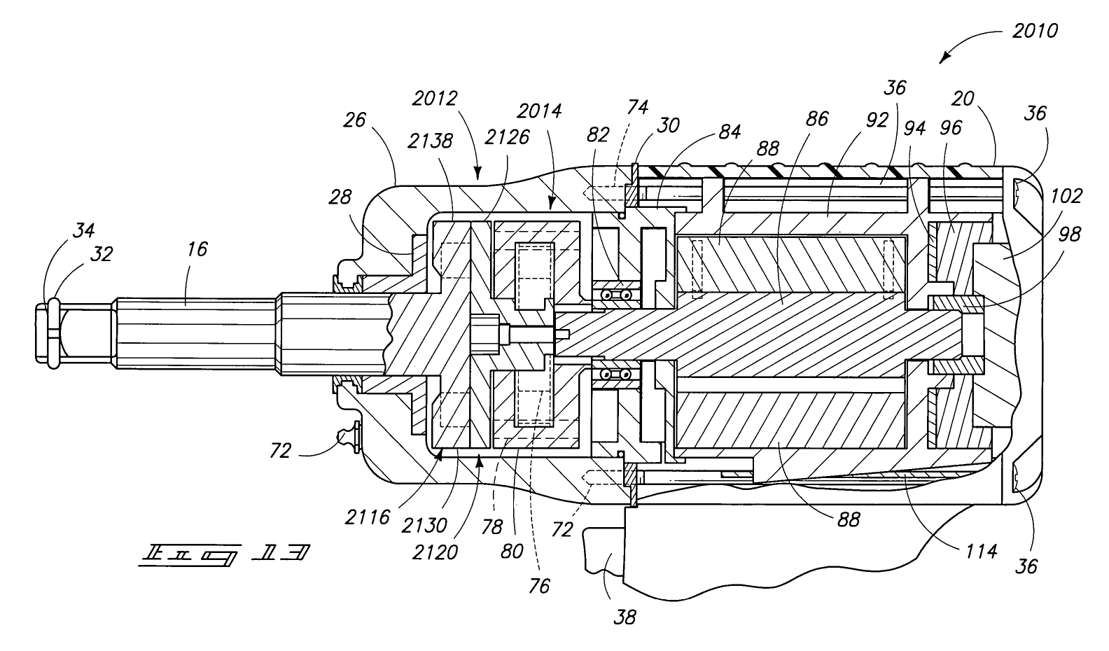

FIG. 4 illustrates in assembly the components of impact wrench 10, including resilient rotary coupling device 12. More particularly, coupling device 12 is shown assembled between impact mechanism 14 and anvil 16. Additionally, motor 93 and air valve 95 are also shown. Except for the new and novel features of resilient rotary coupling device 12, the remaining features of wrench 10 are presently known in the art. An impact wrench with these remaining features is presently sold commercially as a ½ composite impact wrench, but with a twin hammer, as a Model #1000^{th}, Aircat impact wrench, from Exhaust Technologies, Inc., North 230 Division, Spokane, Wash. 99202. Further details of an alternative construction for a twin hammer mechanism are disclosed in U.S. Pat. No. 6,491,111, herein incorporated by reference. With respect to the alternative hammer construction depicted in the embodiment of FIGS. 11-12, U.S. Pat. No. 3,414,065 discloses a typical construction for a twin-pin hammer, or clutch, assembly, herein incorporated by reference.

FIG. 5 illustrates resilient rotary coupling device 12 in an exploded perspective view to better show cooperation between jaw portion 116, spring 118, and jaw portion 120. This cooperation provides rotational compliance, or sprung deformation between hammer shank 122 and anvil 16. Jaw portion 120 is provided on a first coupling member 126 that is directly affixed onto a hammer shank 122. Hammer shank 122 drives first coupling member 126 in response to hammer impacts from hammer 14 (see FIGS. 3-5).

First coupling member 126 includes a drive pawl 134, a guide pawl 135, and a cylindrical base portion 142 which cooperate to provide a first torsional coupling member 130. Drive pawl 134 includes a drive finger, or dog leg, 138. Pawls 134, 135 and base portion 142 extend integrally from a drive plate 127 to form first coupling member 126. According to one construction, pawls 134, 135, base portion 142, plate 127 and hammer shank 122 are machined from a single piece of 8260 case hardened steel.

Second coupling member 128 includes a driven pawl 136, a guide pawl 137, and a cylindrical recess 144 that overlaps with a cylindrical outer portion of base portion 142, in assembly, which cooperate to provide a second torsional coupling member 132. Driven pawl 136 includes a driven finger, or dog leg, 140. Pawls 136, 137 extend integrally from a driven plate 129 to form second coupling member 128. According to one construction, pawls 136, 137, driven plate 129,.enlarged shaft 124, and anvil 16 are machined from a single piece of 8260 case hardened steel.

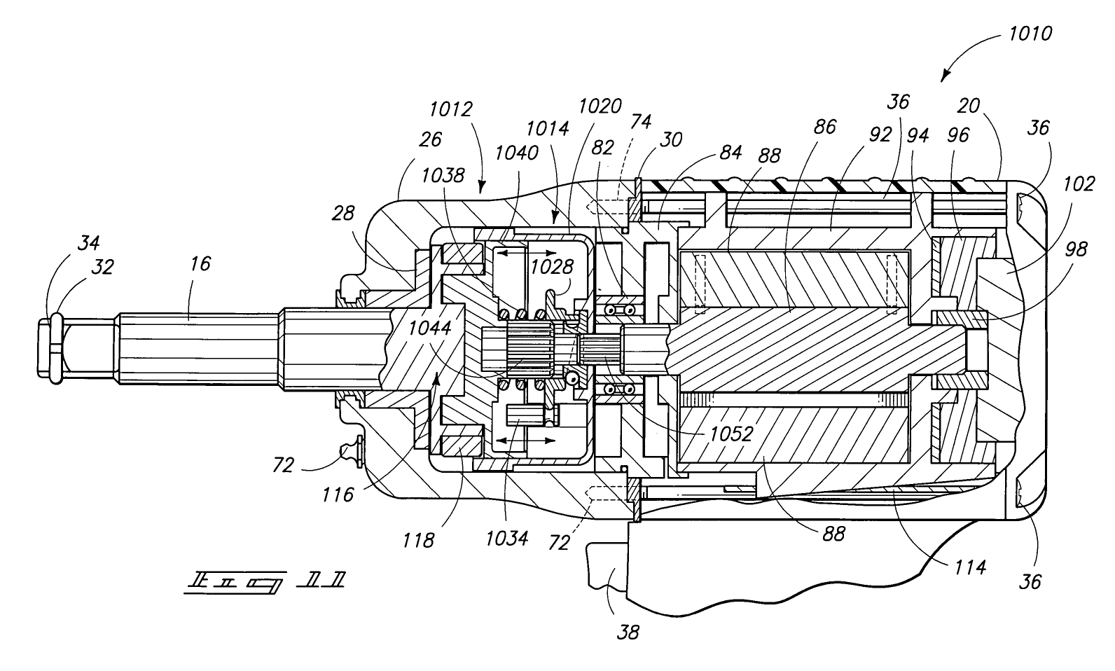

According to one construction, spring 118 is constructed from a single piece of 5160 spring steel that is sized to snugly fit, in assembly, about pawls 134, 135, 136, and 137 and between fingers 138 and 140. Spring 118 has an open slit, or mouth portion, that forces fingers 138 and 140 together, in assembly. Chamfers on the slit ends of spring 118 facilitate assembly. Details of the unloaded assembly configuration are shown and described in reference to FIG. 9 below. Transient rotation impact forces cause rotation between coupling members 126 and 128 which causes fingers 136 and 138 to rotate further apart, thereby forcibly biasing further apart the open slit of spring 118. In this manner, spring 118 provides compliance between coupling members 126 and 128 which mitigates the transfer of peak transient impact forces from hammer shank 122 to anvil 16. According to optional constructions, spring 118 can be laminated from multiple components such as a radial inner c-shaped spring and a radial outer c-shaped spring, or from multiple c-shaped springs that are laminated together along a common axis, next to one another. Further optionally, spring 118 can be constructed from any form of spring material including spring metals and composites, such as fiberglass or carbon fiber composite.

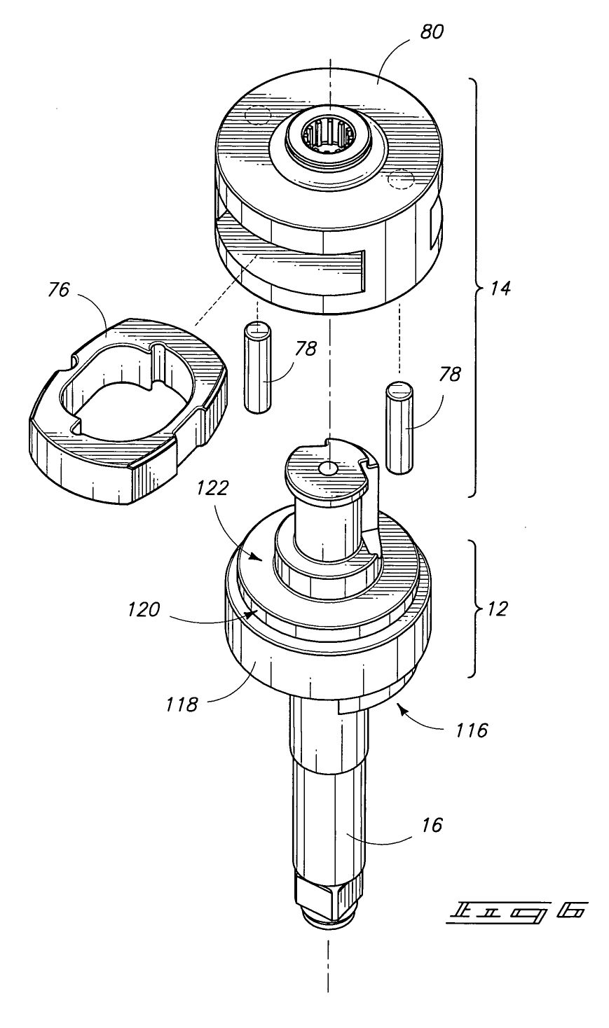

FIG. 6 illustrates resilient rotary coupling device 12 in an assembled-together configuration along with hammer impact mechanism 14 which is shown in an exploded perspective view. Resilient rotary coupling device 12 is shown affixed to anvil 16. Hammer 76 is supported for pivot movement about one of pins 78, which imparts impact between an inner surface of hammer 76 and a corresponding surface on hammer shank 122. The remaining pin 78 limits pivotal movement of hammer 76 an impact cycle. Hammer cage 80 is driven in rotation via an internal spline that couples with an external spline on the rotary air motor. First jaw portion 116 is coupled in resilient rotational relation with second jaw portion 120 via c-shaped spring 118.

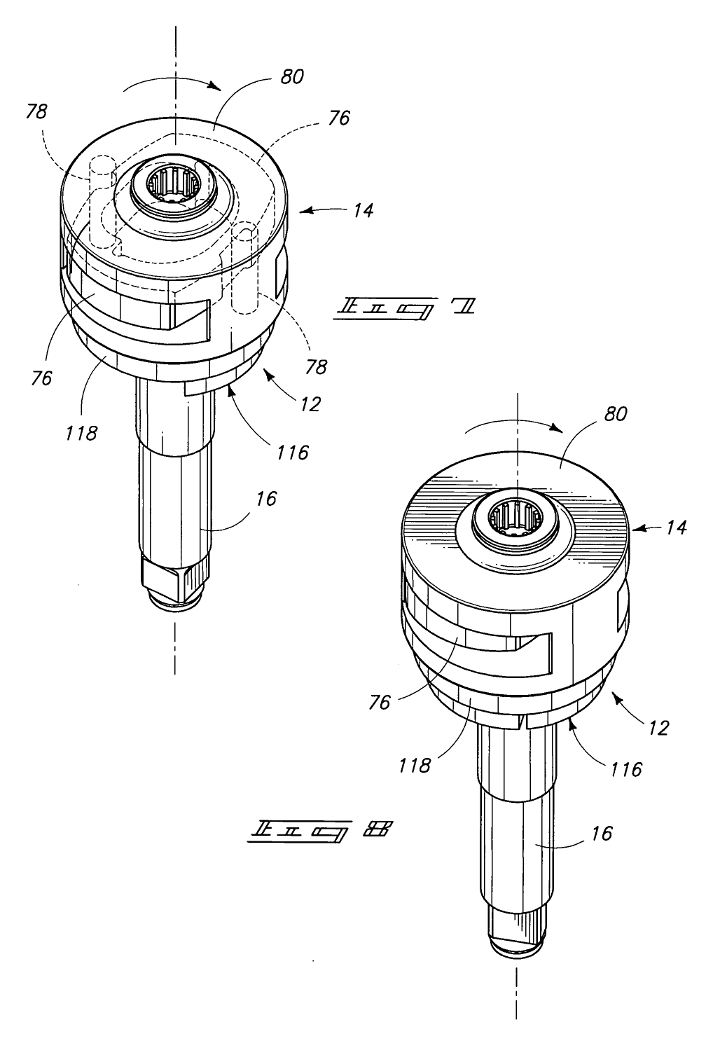

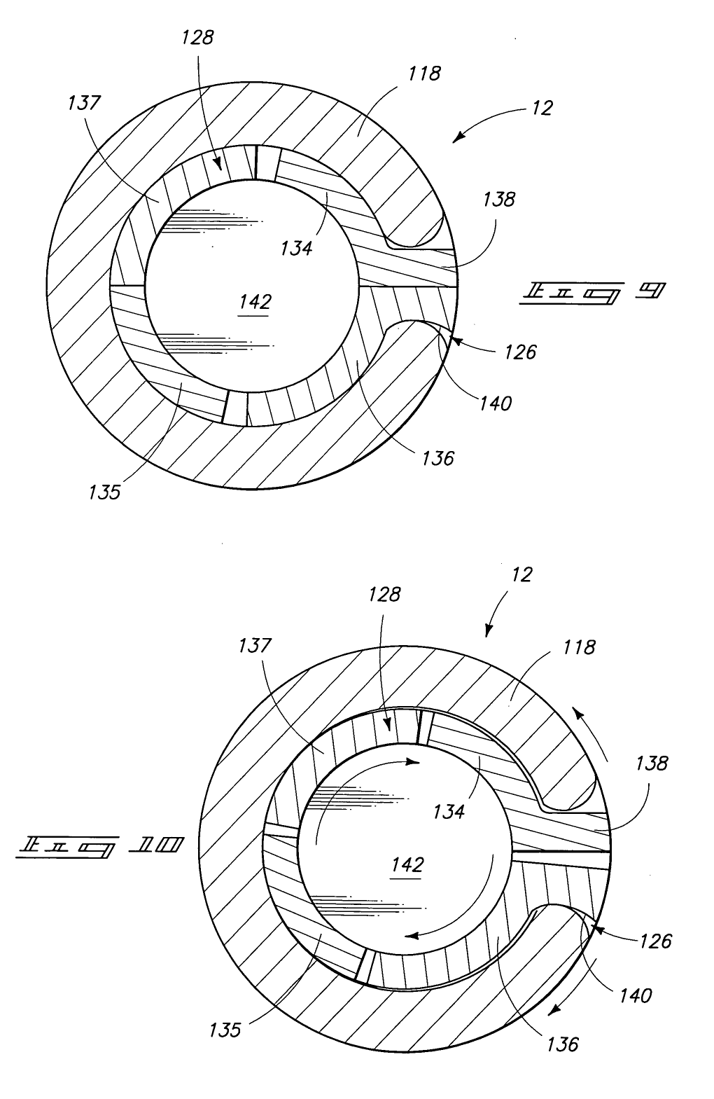

Resilient rotary coupling device 12 is shown assembled together with hammer 14 in FIG. 7. Hammer 76 is shown in a position just prior to impact with a hammer surface on hammer shank 122 (see FIG. 6). Hammer 76 is shown later in time in FIG. 8 just after impact with the hammer surface on the hammer shank, which causes hammer 76 to pivot.

FIG. 9 depicts resilient rotary coupling device 12 as assembled together without any impact load on spring 118. Spring 118 is sized to snugly assemble together about pawls 134-137 and in engagement with drive finger 138 and driven finger 140. In this configuration, a ten degree gap is provided between pawls 134, 137 and pawls 135, 136.

FIG. 10 depicts resilient rotary coupling device 12 while under an impact load from an impact hammer which causes spring 118 to flex into a more open position as drive finger 138 and driven finger 140 forcibly urge apart the slit in spring 118. Accordingly, spring 118 provides sufficient compliance for pawls 134, 135 of first coupling member 126 to rotate five degrees relative to pawls 136, 137 of second coupling member 128. After the transient impact, spring 118 recompresses to force first coupling member 126 and second coupling member 128 back into the positions depicted in FIG. 9.

FIGS. 11 and 12 show a first alternative embodiment where a resilient rotary coupling device 1012 is provided on a twin-pin hammer mechanism 1014. Resilient rotary coupling device 1012 is essentially identical to resilient rotary coupling device 12 of FIGS. 1-10 with the exception that the single hammer mechanism of FIGS. 1-10 has been replaced with the twin-pin hammer mechanism 1014 of FIGS. 11-12.

Twin-pin hammer mechanism 1014 includes a hammer housing 1020, a hammer base 1040, a sleeve 1024, a ball 1026, a cam 1028, a pair of pins (or dogs) 1032, 1034, a coil spring 1038, a bearing shaft 1042, an external spline 1044, an alignment surface 1046, a hammer 1048, and a pair of hammer lugs 1050. Cam 1028 has a v-shaped cam surface 1030. Hammer housing 1020 includes an internal spline surface 1022 that couples with an external spline on a drive motor, similar to that found on motor 93 of FIG. 3. Cam 1028 includes a flange 1036 that drives pins 1032 in axially extended and retracted positions while acting against spring 1038 to compress and release spring 1038. Cam 1028 includes an axially extending, symmetrical, and v-shaped cam surface 1030. When ball 1026 ramps up the v-shaped peak on surface 1030, spring 1038 is compressed and pins 1032 and 1034 are axially displaced to engage with hammer lugs 1050, generating an impact therebetween. Further details of another twin dog-leg impact hammer mechanism are provided in U.S. Pat. No. 3,908,768, herein incorporated by reference.

Resilient rotary coupling device 1012 is provided by jaw portions 116, 120 and spring 118 to impart rotational resilience between hammer 1014 and anvil 116. It is envisioned that devices 12 (of FIGS. 3-5) and 1012 can be provided in conjunction with various alternatively constructed hammer and anvil devices.

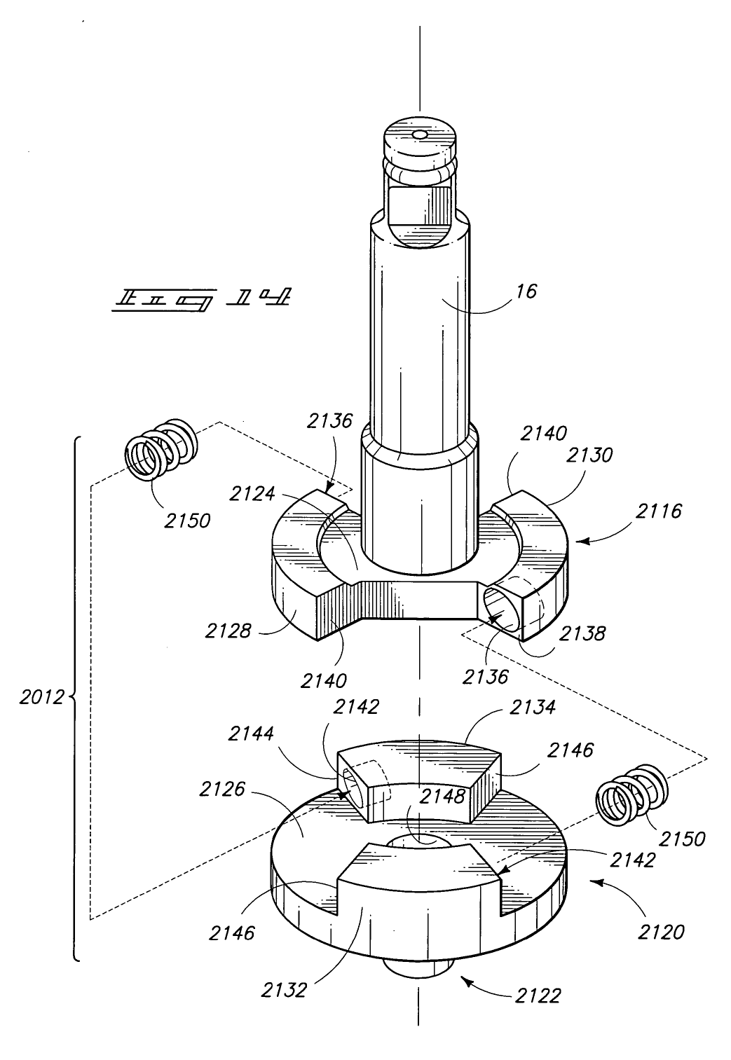

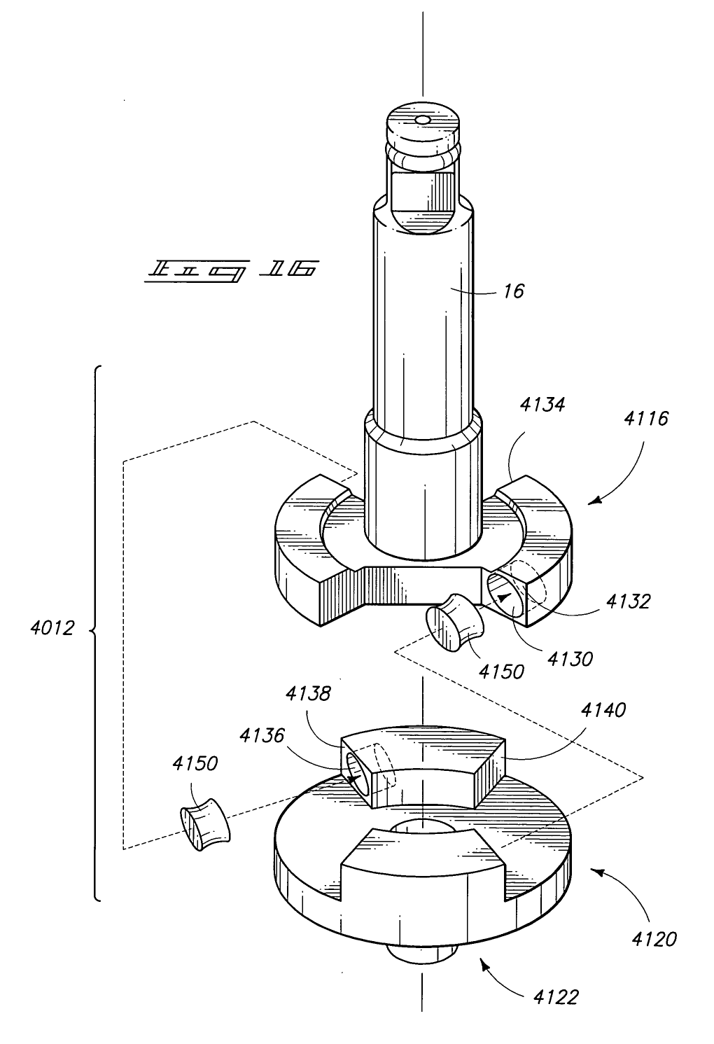

FIGS. 13-14 and 17-19 illustrate a second alternative embodiment for the resilient rotary coupling devices 12 and 1012 of FIGS. 1-10 and FIGS. 11-12, respectively. FIGS. 15 and 16 illustrate modifications to the resilient rotary coupling device 2012 of FIGS. 13-14 and 17-19; namely devices 3012 and 4012, respectively. More particularly, resilient rotary impact device 2012 is driven by hammer impact mechanism 2014. Hammer impact mechanism 2014 is essentially the same as hammer impact mechanism 14 of FIGS. 1-10.

As shown in FIG. 13, resilient rotary coupling device 2012 includes a pair of jaw portions 2116 and 2120. A first coupling member is provided by jaw portion 2120 via a pair of drive pawls 2132 and 2134 provided atop a drive plate 2126. A second coupling member is provided by jaw portion 2116 via a pair of driven pawls 2128 and 2130 provided by a driven plate 2124. A bore 2142 is provided in drive face 2144 sized to snugly receive a steel coil spring 2150. An opposite end of spring 2150 acts against driven face 2136. Likewise, a bore 2136 is provided in driven face 2138 and sized to snugly receive another steel coil spring 2150. An opposite end of another spring 2150 acts against drive face 2142. Faces 2146 on each pawl 2132 and 2134 abut against complementary faces 2140 on pawls 2128 and 2130 to limit relative rotation between jaw portions 2116 and 2120. In assembly, springs 2150 provide a shock attenuating coupling device between the jaw portions 2116 and 2120.

A hammer shank 2122 is integrally formed onto jaw portion 120. Hammer shank 2122 is identical to shank 122 in the embodiment of FIGS. 1-10. Coupling device 2012 is substituted for device 12 in the impact wrench 12 of FIGS. 1-10. A cylindrical recess 2148 is also provided in drive plate 2126. Hence, resilient rotary coupling device 2012 is configured to attenuate impact transmission from hammer shank 2122 to anvil 16. Compliance is provided in a forward rotary direction. No compliance is provided in an opposite, reverse direction.

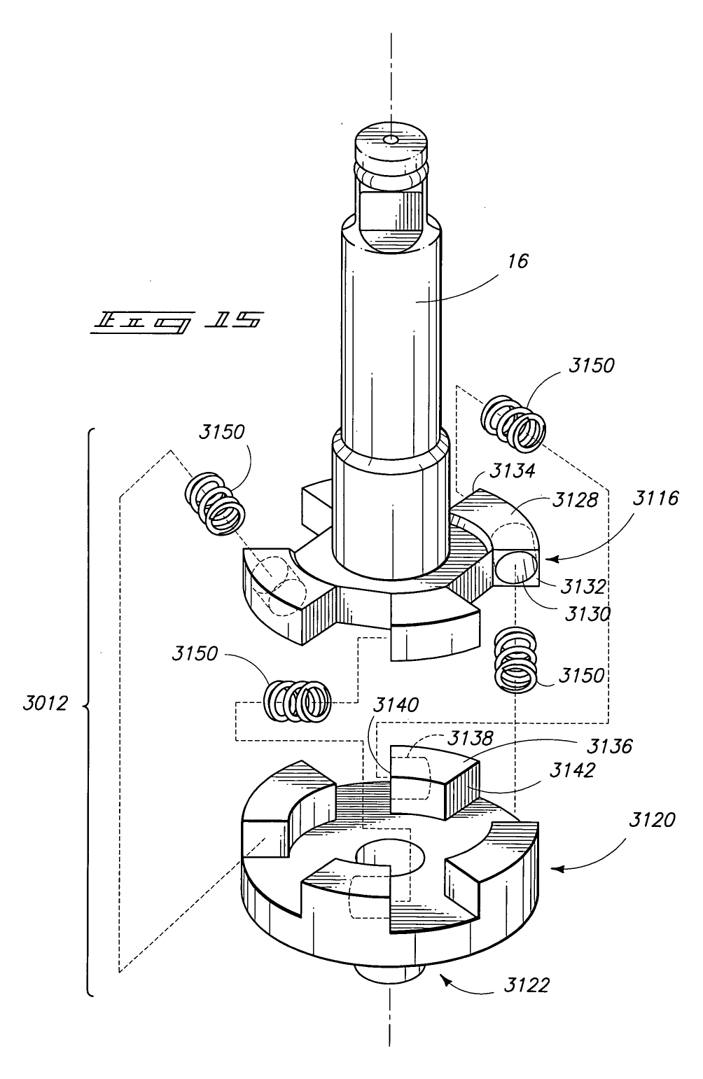

FIG. 15 illustrates an alternative construction resilient rotary coupling device 3012 over that depicted by device 2012 in FIG. 14. Hence, resilient rotary coupling device 2012 is configured to attenuate impact transmission from hammer shank 2122 to anvil 16.

FIG. 15 illustrates an alternative construction resilient rotary coupling device 3012 over that depicted by device 2012 in FIG. 14. However, jaw portion 3120 has four pawls 3136, with an opposed pair of the pawls having a drive face 3140 with a bore 3138 and a back face 3142. Likewise, jaw portion 3116 has four pawls 3128, with an opposed pair of the pawls having a driven face 3132 with a bore 3130 and a back face 3134. Hence, four springs 3150 are interposed between the respective pawls 3136 and 3128 to provide twice the spring force over that provided by coupling device 2012 of FIG. 14. Therefore, four springs 3150 provide resilient rotary coupling between hammer shank 3122 and anvil 16 in a forward drive direction. No compliance is provided in an opposite, reverse direction.

FIG. 16 illustrates a second alternative construction resilient rotary coupling device 4012 over that depicted by device 2012 in FIG. 14. However, urethane springs 4150 are provided in bores 4130 and 4136 within faces 4132 and 4138 of respective pawls of jaw portions 4116 and 4120, respectively. Otherwise, jaw portions 2116 and 2120 are essentially identical to jaw portions 2116 and 2120 of FIG. 14. Faces 4134 and 4140 interact to provide a non-compliant, direct-drive coupling in a reverse direction of device 4102.

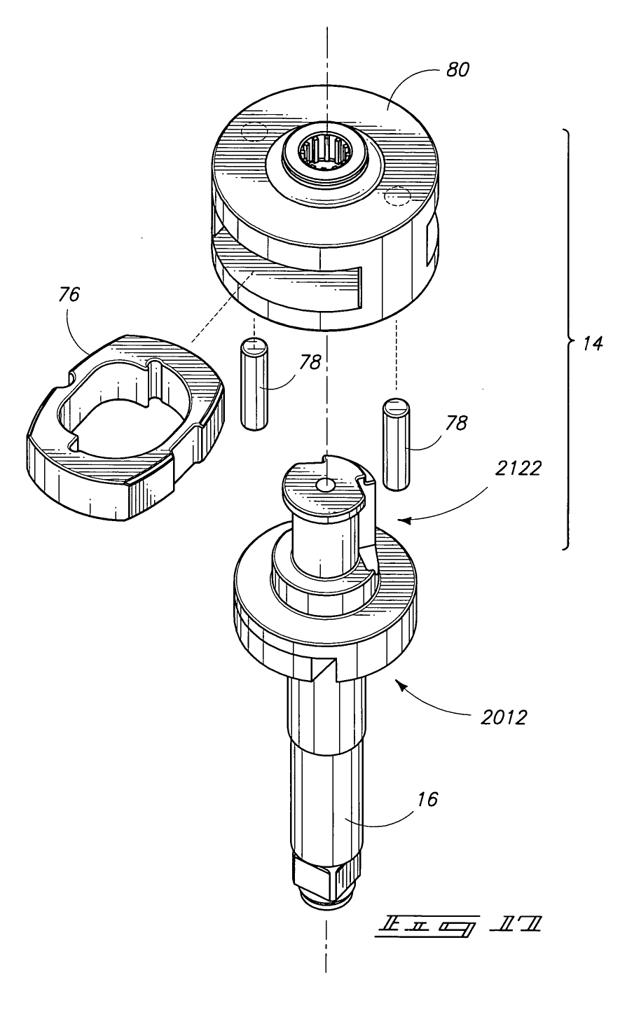

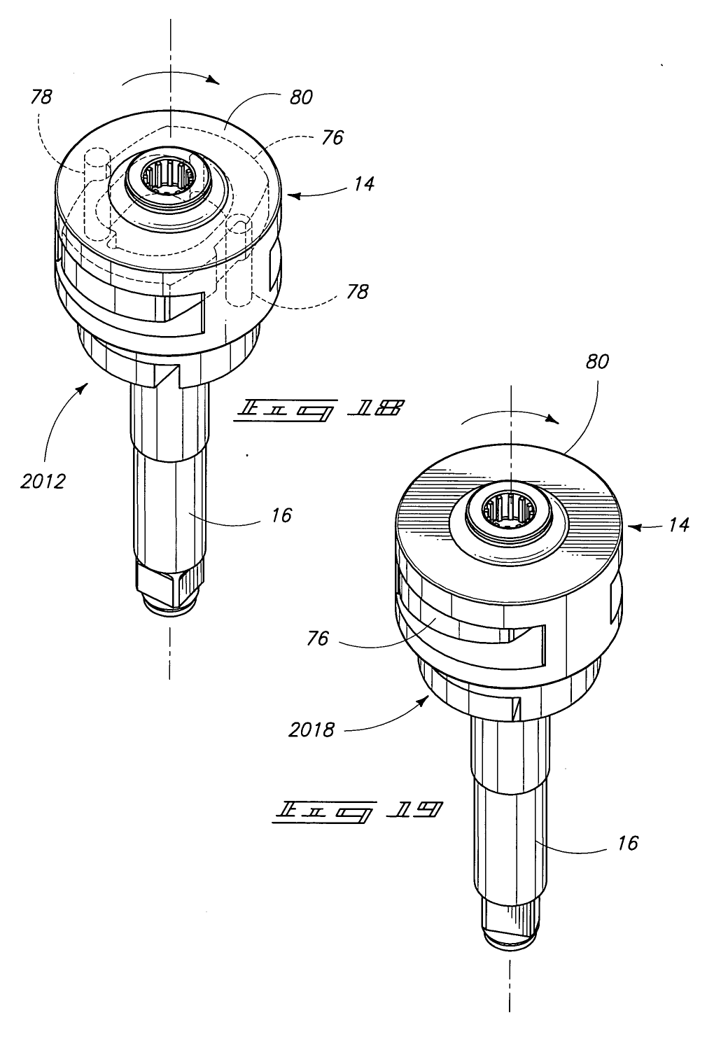

FIG. 17 illustrates resilient rotary coupling device 2012 of FIG. 14 along with a hammer 14 shown in exploded perspective view. FIG. 18 illustrates device 2012 in an assembled state, prior to a forward impact against hammer 76. FIG. 19 illustrates device 2012 immediately after a forward impact.

It is understood that a body of resilient coupling material can be provided in any of a number of configurations in order to provide a shock attenuating coupling device between a first coupling member and a second coupling member. Further optionally, the body of resilient material can be provided so as to attenuate impacts in both forward and reverse directions. For example, in device 2012 of FIG. 14, bores and springs can also be provided in face 2140 of pawl 2128 and face 2146 of pawl 2134 in addition to the springs already shown.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A shock attenuating coupling device for a rotary impact tool for drivingly connecting a hammer mechanism to a drive anvil, comprising:
a first coupling member having a longitudinal drive portion with an input end configured to couple for rotation with a hammer mechanism and an output end with a first jaw portion;
a second coupling member with an output end configured to couple for rotation with a drive anvil and an input end with a second jaw portion configured to cooperate in longitudinally overlapping and circumferentially spaced-apart relation with the first jaw portion; and
a body of resilient material interposed between the first jaw portion and the second jaw portion.

2. The rotary impact tool coupling device of claim 1 wherein the body of resilient material comprises a spring.

3. The rotary impact tool coupling device of claim 2 wherein the spring comprises a c-shaped spring configured to be urged open responsive to relative rotation between the first jaw portion and the second jaw portion.

4. The rotary impact tool coupling device of claim 2 wherein the spring comprises a coil spring.

5. The rotary impact tool coupling device of claim 2 wherein the spring comprises a urethane plug.

6. The rotary impact tool coupling device of claim 1 wherein the first jaw portion comprises a drive plate with at least two axially projecting drive pawls.

7. The rotary impact tool coupling device of claim 6 wherein the second jaw portion comprises a drive plate with at least two axially projecting driven pawls configured to engage in axially overlapping relation with the drive pawls of the drive plate.

8. The rotary impact tool coupling device of claim 7 wherein one of the drive pawl and the driven pawl comprises a bore configured to receive the body of resilient material.

9. The rotary impact tool coupling device of claim 8 wherein the body of resilient material comprises a spring.

10. The rotary impact tool coupling device of claim 8 wherein the body of resilient material comprises a urethane plug.

11. The rotary impact tool coupling device of claim 1 wherein the first jaw portion and the second jaw portion each comprise a pie-shaped pawl.

12. A rotary impact tool, comprising:
a housing;
a hammer mechanism;
a drive anvil; and
a resilient rotary coupling device interposed between the hammer mechanism and the drive anvil and configured to attenuate impacts from the hammer mechanism to the drive anvil.

13. The rotary impact tool of claim 12 further comprising a pneumatic motor.

14. The rotary impact tool of claim 13 wherein the hammer mechanism comprises a carrier mechanism positioned in the housing and a hammer member pivotally positioned within the cage member for rotation with the cage member under drive from the pneumatic motor.

15. The rotary impact tool of claim 12 wherein the resilient rotary coupling device comprises a drive shaft with a drive plate and at least one axially projecting drive pawl, a driven shaft with a driven plate and at least one axially extending driven pawl, and a spring interposed between one of the drive pawls and a respective one of the driven pawls.

16. The rotary impact tool of claim 15 wherein the drive pawl and the driven pawl are configured in longitudinally overlapping and circumferentially spaced-apart relation.

17. The rotary impact tool of claim 16 wherein the spring renders the rotary coupling device flexible in directions of rotation.

18. The rotary impact tool of claim 12 wherein the resilient rotary coupling device comprises a first coupling member, a second coupling member, and a spring interposed between the first coupling member and the second coupling member.

19. The rotary impact tool of claim 18 wherein the spring comprises a c-shaped spring having a slit with a pair of ends.

20. The rotary impact tool of claim 19 wherein the first coupling member and the second coupling member each comprises at least one pawl with a dog leg configured to engage with one of the pair of ends of the c-shaped spring.

21. The rotary impact tool of claim 20 wherein the first coupling member is rigidly coupled to the hammer mechanism and the second coupling member is rigidly coupled to the anvil.

22. A rotary impact attenuating device for an impact tool, comprising:
a first coupling member having a drive shaft and at least one engagement surface;
a second coupling member having a driven shaft and at least one engagement surface configured to overlap and interdigitate with a respective one of the at least one engagement surface on the first coupling device; and
a spring mounted between the first coupling member of the drive shaft and the second coupling member of the driven shaft to impart rotary resilience between the first coupling member and the second coupling member.

23. The rotary impact tool of claim 22 wherein the first coupling member and the second coupling member each comprises a jaw portion.

24. The rotary impact tool of claim 23 wherein the jaw portion comprises at least two pawls.

25. The rotary impact tool of claim 24 wherein the spring comprises a c-shaped spring, one pawl on the first coupling member comprises a drive finger, and another pawl of the second coupling member comprises a driven finger, wherein the drive finger and the driven finger engage with opposed ends of the c-shaped spring to urge apart the ends of the spring and provide shock attenuation between the first coupling member and the second coupling member.

26. The rotary impact tool of claim 25 further comprising another pawl on the first coupling member and another pawl on the second coupling member, wherein the another pawl on the first coupling member and the another pawl on the second coupling member are configured to limit maximum torsional displacement between the first coupling member and the second coupling member.

27. The rotary impact tool of claim 12 wherein at least one of the one pawl and at least one of the another pawl are configured to directly couple together the first coupling member and the second coupling member when rotated in a reverse direction, and wherein the spring is urged apart when rotated in a forward direction.

28. The rotary impact tool of claim 23 wherein the jaw portion of the first coupling member and the jaw portion of the second coupling member each comprises at least one pawl.

29. The rotary impact tool of claim 28 wherein one of the jaw portions comprises a bore, and the spring is received in the bore.

30. The rotary impact tool of claim 29 wherein the spring comprises a coil spring.

31. The rotary impact tool of claim 29 wherein the spring comprises a urethane plug.

32. The rotary impact tool of claim 29 wherein the spring is configured to compress between the pawls when the first coupling member and the second coupling member are driven by an impact hammer in a forward direction.
